(19) United States
(12) Patent Application Publication
(10) Pub. No.: US 2010/0200031 A1
(43) Pub. Date: Aug. 12, 2010

(54) Length Adjustable Crutch

(75) Inventor: Alfred Michael Vegvary, Surfers Paradise (AU)

Correspondence Address: Jonathan P. O''Brien, Ph.D.;Honigman Miller Schwartz and Cohn, 350 East Michigan Avenue, Suite 300, KALAMAZOO, MI, 49007, US

(73) Assignee: Wayne WARD, Blue Knob (AU)

(21) Appl. No.: 12/664,362

(22) PCT Filed: May 28, 2008
(86) PCT No.: PCT/AU2008/000747

§ 371 Date: Apr. 14, 2010

(30) Foreign Application Priority Data
May 28, 2007 (AU) 2007902841

(51) Int. Cl. A61H 3/02

(52) U.S. Cl. 135/69

(57) ABSTRACT

An adjustable length crutch including at least one support portion to support at least a portion of the weight of a user, a leg portion associated with the at least one support portion and having a foot adapted to abut the ground in use to balance the user and a length adjustment mechanism to adjust the separation between the at least one support portion and the foot to adjust the effective length of the crutch.

### FIELD OF THE INVENTION

The present invention relates to crutches and other medical aids for supporting a person's weight during therapy or rehabilitation and particularly to those which are length adjustable to allow separation of the support and the ground.

### BACKGROUND ART

Most crutches used today are adjustable to some extent so that they can be customized to fit sizes and shapes of different patients. However, many crutches are difficult to adjust, often requiring tools. Further, ranges of such adjustments for most crutches are relatively small so that hospitals, clinics and medical wholesalers and retailers must stock a spectrum of crutch sizes which can be used by small children to very tall adults, such as, 6½ foot basketball players. Maintaining such inventories is expensive. Few prior art crutches can be adjusted throughout this entire range.

Crutches which can be adjusted to accommodate wide ranges of patient sizes are described in U.S. Pat. No. 2,172,047 to Jacobucci; No. 3,034,524 to Klino; No. 3,157,189 to Farnham; No. 3,730,198 to Johnston et al.; and, No. 5,025,820 to Gamper. An adjustable and collapsible crutch described by Jacobucci (U.S. Pat. No. 2,172,047) is constructed primarily of metallic tubing and tubing joints which are coupled together to generally form two sections which can be slid relative to one another. One of these sections A has openings along a length thereof, while the other section B has what appear to be spring-loaded metallic bolts which are driven into the openings by springs, but which can be pulled out of the openings by pinching together handles attached to the bolts. Although the Jacobucci adjustable and collapsible crutch has many advantages over normal wooden crutches, it appears that it would be too heavy and expensive for general use. In this regard, it is thought that the members of this crutch would have to be constructed of a strong metal, such as steel, in order to have the necessary strength and durability for continuous use.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a length adjustable crutch, which may at least partially overcome at least one of the abovementioned disadvantages or provide the consumer with a useful or commercial choice.

With the foregoing in view, the present invention in one form, resides broadly in an adjustable length crutch including at least one support portion to support at least a portion of the weight of a user, a leg portion associated with the at least one support portion and having a foot adapted to abut the ground in use to balance the user and a length adjustment mechanism to adjust the separation between the at least one support portion and the foot to adjust the effective length of the crutch.

The crutch of the present invention is particularly adapted to be adjustable in order to allow quick and easy length configuration for users of different heights. The crutch of the present invention may also assist a user of limited mobility when standing and sitting.

The crutch of the present invention is particularly well adapted to use in therapeutic or rehabilitation situations. Typically, crutches are used to assist the mobility of users whilst they are recovering from injury or treatment for medical conditions or surgery. As such, they are normally a temporary aid which is dispensed with once the user has recovered their mobility. In certain situations, crutches are provided for long-term use.

In the context of the present invention, the term “crutch” is considered to include other mobility aids such as walking sticks, walking frames and the like, and is not intended to be limiting.

The crutch of the present invention and preferably includes an upper assembly and a lower leg portion. The upper assembly will typically include the at least one support portion and at least one elongate strut member which will typically form a majority of the height of the crutch.

As mentioned above, the at least one support portion of the crutch of the present invention will preferably form part of the upper assembly of the crutch. The at least one support portion may be provided as a support for a user's hand, underarm or shoulder, forearm or any combination of these. The type and configuration of the support portion(s) provided will typically depend upon the configuration of the crutch itself.

The least one support portion will typically be arcuate in cross-section as the portion will normally abut a part of a person's body and as such, will normally be rounded for comfort. The least one support portion may also be or include a resilient portion in order to minimise discomfort during periods of use.

As mentioned above, the type and configuration of the support portion(s) will typically depend upon the configuration of the crutch itself. There are two main crutch configurations.

In the first main crutch configuration, the upper assembly of the crutch includes a pair of spaced apart strut members with a shoulder or underarm rest at an at upper end and extending between the strut members. The underarm rest will normally be fixed and will also function to space the strut members at the upper end. A hand support portion will typically be provided extending between the strut members approximately at arm's length downwardly from the underarm rest. Typically, the hand support portion will be temporarily fixed relative to the strut members, but the hand support portion will be movable in order to adjust in the spacing between the hand support portion and the underarm rest.

The hand support portion preferably has engagement means such as shear pins for selectively engaging openings in strut members in order to temporarily fix the position of the hand support portion. Normally a number of openings are provided in order to adjust the position of the hand support portion.

According to this configuration, the strut members of the upper assembly typically taper towards each other at a lower end. Normally, a guide portion is provided at or adjacent the lower end of the upper assembly in order to receive and/or guide the leg portion.

According to the second main crutch configuration, a single strut member is provided with a forearm support portion located at or adjacent and at the end and thereof. The forearm support portion is typically fixed relative to the strut member. The strut member is normally provided with at least a hollow portion at or adjacent the lower end. Typically, the strut member is entirely hollow.

A hand support portion is normally provided extending from the strut member approximately at arm's length downwardly from the underarm rest. Typically, the hand support portion will be temporarily fixed relative to the strut members, but the hand support portion will be movable in order to adjust in the spacing between the hand support portion and the underarm rest.

According to the second crutch configuration, the leg portion is normally receive at least partially within the hollow strut member and is at least temporarily fixed relative thereto.

According to both of the above configurations, the leg portion typically includes an elongate member which is at least temporarily securable relative to the upper assembly in order to at least temporarily fixed the length of the crutch or more particularly the distance between the foot portion of the leg and of the least one support portion. The leg member may be hollow or solid depending upon material and strict requirements. For example, the leg member may be manufactured from a metal or other material providing sufficient strength.

The leg portion will typically have a resilient foot in order to minimise slippage of the crutch in use. The foot also preferably increases the footprint area to maximise group.

The leg member may be of any shape but typically will be round or circular in cross-section.

The adjustable length crutch of the present invention also includes a length adjustment mechanism to adjust the separation between the at least one support portion and the foot to adjust the effective length of the crutch.

The length adjustment mechanism of the present invention is preferably provided in one of two main preferred forms.

According to the first preferred form, the length adjustment mechanism has a threaded or helical configuration and the components of the length adjustment mechanism are therefore adapted for this purpose. In particular, the components of the length adjustment mechanism of the first preferred form include a threaded member, drive means to rotate the threaded member in at least one, and typically both directions, and a telescopic leg portion associated with the threaded member and which extends and retracts relative to the upper assembly upon rotation of the threaded member by the drive means.

Typically, the drive means will be provided in association with the upper assembly. Further, a lower part of the upper assembly may be provided with a guide portion to guide and/or stabilise the leg portion or threaded member during extension, retraction and in use.

Typically, the drive means may be associated with a further guide means. The drive means will typically be a lightweight motor, preferably an electric motor which is battery-powered, although other types may be used. Activation of the drive means will typically cause rotation of the threaded member and may do so in any manner. The electric motor (and/or battery) may be positioned in any location on the crutch, for example, in association with the further guide means or in/on the underarm support.

The threaded member will typically be an elongate rod with at least one threaded portion extending at least partially, and preferably completely, over the length of the rod. The rod will typically be circular cross-section, but the shape is not essential.

According to an alternative embodiment, the drive means may be associated with a shaft with a shaped, typically threaded, portion adapted to facilitate extension and retraction of a telescopic leg member through rotation of the shaft. According to this embodiment, at least a portion of each component of the telescopic leg member may be threaded and associated with a shaft in order to extend and retract.

Each of the components of the telescopic leg member may be provided with an internally threaded portion adapted to engage with the threaded rod or shaft in order to extend and retract. Typically, extension of the innermost telescopic member is actuated initially by rotation of the threaded rod or shaft relative to the respective internally threaded portion. Once the innermost telescopic member has reached the limit of its movement, the further rotation or shaft or threaded member may disengage from the internally threaded portion of the innermost member and continued rotation will then extend the next innermost telescopic member and so on until the telescopic leg member reaches the desired length or the limit of its extension. Retraction of the telescopic leg member will preferably occur in the opposite manner.

According to the second preferred form, the length adjustment mechanism includes one or more rams associated with an extendable and retractable scissor drive assembly which is in turn associated with a leg member. According to this embodiment, the leg member will typically be of fixed length and be extended and retracted to the desired position by the scissor drive assembly. The hydraulic rams will typically force the extension and retraction of the scissor drive assembly.

Typically there will be a pair of hydraulic rams, but the rams may be pneumatic or the like. Each of the hydraulic rams will typically be mounted in a pivotal fashion to a cross piece provided in association with the upper assembly. The hydraulic rams are each typically associated with a cross-piece and a portion of the scissor drive assembly.

The scissor drive assembly will typically include a plurality of pairs of arm members, the arm members of each pair typically connected to each other approximately centrally along the length. Each end of each arm member is then typically attached to an end of an arm member of an adjacent pair, which are similarly connected to each other. The first pair of arm members (the uppermost pair) will normally be associated with one of the rams.

There may be an intervening pivotably mounted plate means or the rams may attach directly to an end of each of the arm members. Provision of a number of pairs of arm members allows the extension and retraction of the leg member through the scissor action and control over the degree of extension and retraction of the scissor drive assembly will preferably act to control the separation of the foot and the at least one support portion.

The last pair of arm members (the lowermost pair) will normally be associated with the leg member. One or more intervening members may be provided. The rams of this configuration may be provided between a pair of cross-piece members which are attached to or interposed between strut or shaft members provided as a part of the upper assembly.

The extension and retraction (and typically the speed of extension and retraction) of the leg member will typically be actuated using an actuation means in communication with the drive needs. Normally the actuation means will be a depressible or button or switch, but other components may be included in the actuation means such as speed controls. Normally, the actuation means will be associated with a hand support portion so as to be conveniently located for a user when the crutch is in use. Preferably, the actuation means is located on the hand support portion. It is anticipated however, that the actuation means may be located remotely from the hand support portion in order to minimise the chance of accidental activation of the length adjustment mechanism. If located remotely, the actuation means is preferably spaced such that the actuation is unlikely to be accidental but should be within easy reach of the user without removing their hands from the support portion.

### BRIEF DESCRIPTION OF THE DRAWINGS

Various embodiments of the invention will be described with reference to the following drawings, in which:

FIG. 1A is a front view of an adjustable length crutch according to one embodiment of the present invention in the extended condition.

FIG. 1B is a front view of the adjustable length crutch as illustrated in FIG. 1A in the contracted condition.

FIG. 2A is a front view of an adjustable length crutch according to a second embodiment of the present invention in the extended condition.

FIG. 2B is a front view of the adjustable length crutch as illustrated in FIG. 2A in the contracted condition.

FIG. 3 is a perspective view of the adjustable length crutch as illustrated in FIG. 2A.

### DETAILED DESCRIPTION OF THE PREFERRED EMBODIMENT

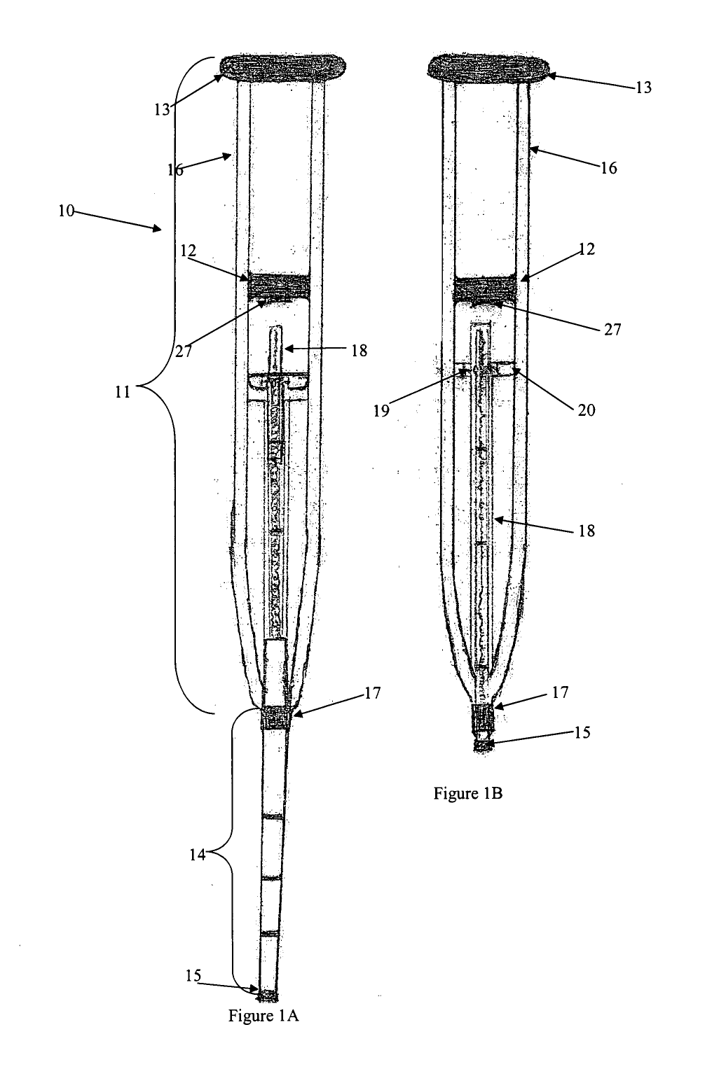

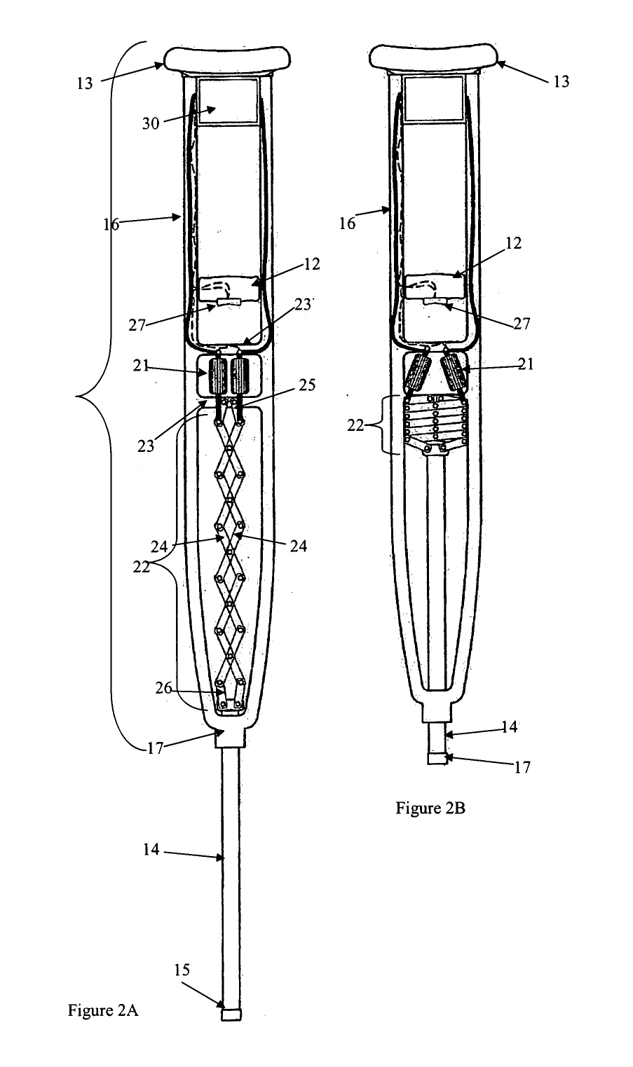

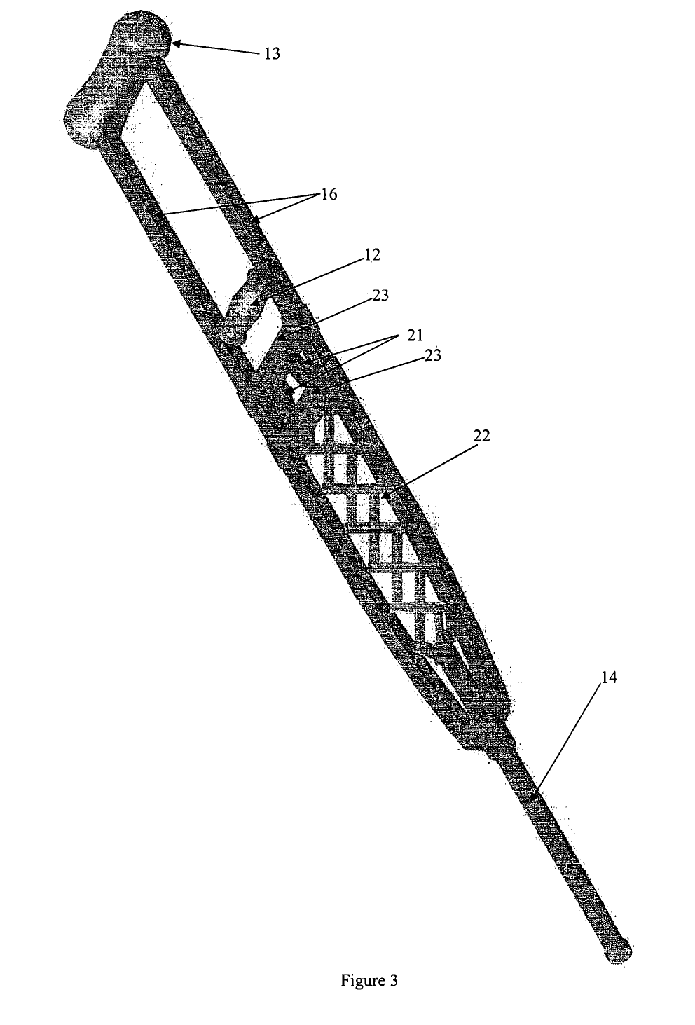

According to a particularly preferred embodiment, an adjustable length crutch is provided. A pair of alternative preferred embodiments illustrated, the first preferred embodiment illustrated in FIGS. 1A and 1B and the second preferred embodiment illustrated in FIGS. 2A, 2B and 3.

Referring firstly to the common features of the crutch as illustrated in all Figures, the adjustable length crutch 10 includes an upper assembly 11 including a hand support 12 and an underarm support 13 to support a portion of the weight of a user, and a leg 14 having a foot 15 adapted to abut the ground in use to balance the user associated upper assembly 11. A length adjustment mechanism is provided to adjust the separation between the supports 12, 13 and the foot 15 to adjust the effective length of the crutch 10.

The upper assembly 11 of the crutch 10 includes a pair of spaced apart struts 16 with the underarm support 13 at an upper end and extending between the struts 16. The underarm support 13 is fixed and also functions to space the struts 16 at the upper end. The hand support 12 extends between the struts 16 approximately at arm's length downwardly from the underarm support 13. The hand support portion will usually be temporarily fixed relative to the struts 16, but the hand support 12 is be movable in order to adjust in the spacing between the hand support 12 and the underarm support 13.

According to this configuration, the struts 16 of the upper assembly 11 taper towards each other at a lower end as illustrated. A guide portion 17 is provided at or adjacent the lower end of the upper assembly 11 in order to receive and/or guide the leg 14.

Turning now to the specific embodiment illustrated in FIG. 1A and 1B, the length adjustment mechanism has a threaded or helical operation and the components of the length adjustment mechanism therefore adapted for this purpose. In particular, the components of the length adjustment mechanism include a threaded rod 18, an electric drive motor 19 to rotate the threaded rod 18 in both directions, and a telescopic leg 14 associated with the threaded rod 18 and which extends and attracts relative to the upper assembly 11 upon rotation of the threaded rod 18 by the electric motor 19.

The electric drive motor 19 is associated with a guide arm 20 extending laterally between the struts 16 of the upper assembly 11. The electric drive motor 19 is a lightweight motor, preferably one which is powered by batteries 30 which are located in or on the underarm support 13. Activation of the electric drive motor 19 causes rotation of the threaded rod 18.

According to this -embodiment, each of the portions of the telescopic leg member 14 are provided with an internally threaded portion (not shown) adapted to engage with the threaded rod 18 in order to extend and retract. Typically, extension of the innermost telescopic member is actuated initially by rotation of the threaded rod 18 relative to the internally threaded portion. Once the innermost telescopic member has reached the limit of its movement, the further rotation of the threaded rod 18 may disengage from the internally threaded portion of the innermost member and continued rotation will then extend the next innermost telescopic member and so on until the telescopic leg member reaches the desired length or the limit of its extension. Retraction of the telescopic leg member will preferably occur in the opposite manner.

According to the second preferred form illustrated in FIGS. 2A, 2B and 3, the length adjustment mechanism includes a pair of hydraulic rams 21 associated with an extendable and retractable scissor drive assembly 22 which is in turn associated with the leg 14. According to this embodiment, the leg 14 is of a fixed length and is extended and retracted to the desired position by the scissor drive assembly 22. The hydraulic rams 21 force the extension and retraction of the scissor drive assembly 22.

Each of the hydraulic rams 21 is mounted in a pivotal fashion to a cross piece 23 provided in association with the upper assembly. The hydraulic rams 21 are each associated with the scissor drive assembly 22.

The scissor drive assembly 22 includes a plurality of pairs of arm members 24, the arm members 24 of each pair connected to each other approximately centrally along their length. Each end of each arm member 24 is then attached to an end of an arm member 24 of an adjacent pair which are similarly connected to each other. The end of each of the uppermost pair of arm members 24 is attached to one of the rams 21 via an intervening pivotably mounted plate 25.

The lowermost pair of arm members 24 is associated with the leg member via intervening members 26.

The rams 21 of this configuration are provided between a pair of cross-piece members 23 which are attached to and interposed between the struts 16 provided as a part of the upper assembly 11.

Again referring to both embodiments, the extension and retraction (and typically the speed of extension and retraction) of the leg 14 is actuated by a depressible or button or switch 27. Normally, the actuation button 27 is associated with the hand support 12 so as to be conveniently located for a user when the crutch is in use.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. An adjustable length crutch including at least one support portion to support at least a portion of the weight of a user, a leg portion associated with the at least one support portion and having a foot adapted to abut the ground in use to balance the user and a length adjustment mechanism to adjust the separation between the at least one support portion and the foot to adjust the effective length of the crutch.

2. An adjustable length crutch as claimed in claim 1 including an upper assembly and a lower leg extendable and retractable relative to the upper assembly.

3. An adjustable length crutch as claimed in claim 2 wherein the upper assembly includes the at least one support portion and at least one elongate strut member.

4. An adjustable length crutch as claimed in any one of the preceding claims wherein the at least one support portion is provided as a support for a user's hand, underarm or shoulder, forearm or combination of these.

5. An adjustable length crutch as claimed in any one of the preceding claims wherein the length adjustment mechanism has a threaded or helical operation and components of the length adjustment mechanism therefore adapted for this purpose.

6. An adjustable length crutch as claimed in claim 5 wherein the components of the length adjustment mechanism include a threaded member, a drive means to rotate the threaded member in at least one direction, and a telescopic leg portion associated with the threaded member and which extends and attracts relative to the upper assembly upon rotation of the threaded member by the drive means.

7. An adjustable length crutch as claimed in claim 6 wherein the drive means is provided in association with an upper assembly of the crutch.

8. An adjustable length crutch as claimed in claim 6 wherein the threaded member is an elongate rod with at least one threaded portion extending at least partially over the length of the rod.

9. An adjustable length crutch as claimed in any one claims 6 to 8 wherein the leg is a telescopic leg with a plurality of leg components, each of the components of the telescopic leg member provided with an internally threaded portion adapted to engage with the threaded member in order to extend and retract.

10. An adjustable length crutch as claimed in claim 9 wherein extension of an innermost telescopic leg component is actuated initially by rotation of the threaded member relative to the internally threaded portion, when the innermost telescopic member has reached the limit of its movement, further rotation of the threaded member disengages the threaded member from the internally threaded portion of the innermost member and continued rotation then extends a next innermost telescopic member iteratively until the telescopic leg member reaches the desired length or the limit of its extension.

11. An adjustable length crutch as claimed in claim 5 wherein the length adjustment mechanism includes one or more rams associated with an extendable and retractable scissor drive assembly which is in turn associated with the leg.

12. An adjustable length crutch as claimed in claim 11 wherein the scissor drive assembly includes a plurality of pairs of arm members, the arm members of each pair connected pivotally to each other approximately centrally along the length, each end of each arm member attached to an end of an arm member of an adjacent pair which are similarly connected to each other except for a pair of arm members associated with at least one ram and a pair of arm members associated with the leg.

13. An adjustable length crutch as claimed in claim 12 wherein pivotably mounted members are provided between the pair of arm members associated with at least one ram and a pair of arm members associated with the leg.

14. An adjustable length crutch as claimed in any one of the preceding claims wherein an actuation means to actuate the length adjustment mechanism is associated with a hand support portion so as to be conveniently located for a user when the crutch is in use.

15. An adjustable length crutch as claimed in any one of the preceding claims wherein the crutch includes a pair of spaced apart strut members with a shoulder support at upper end and extending between the strut members.

16. An adjustable length crutch as claimed in claim 15 wherein a hand support portion is provided extending between the strut members approximately at arm's length downwardly from the underarm rest.

17. An adjustable length crutch as claimed in claim 15 or claim 16 wherein a guide portion is provided in order to receive and/or guide the leg portion.

18. An adjustable length crutch as claimed in any one of claims 1 to 14 including a single strut member provided with a forearm support portion located at or adjacent and at the end and thereof.

19. An adjustable length crutch as claimed in claim 18 wherein the leg is received at least partially within a hollow strut member and is at least temporarily fixed relative thereto.

20. An adjustable length crutch as claimed in any one of the preceding claims wherein the leg has a resilient foot in order to minimise slippage of the crutch in use.
